(19) United States
(12) Patent Application Publication
(10) Pub. No.: US 2004/0032498 A1
(43) Pub. Date: Feb. 19, 2004

(54) Internet camera

(76) Inventors: Jeremy Wyn-Harris, Waipukuarau (NZ); Stephen Arthur Hooker, Te Awamutu (NZ)

Correspondence Address: Michael Molins, Molins & Co., Level 25 Chifley Tower, Sydney, NSW 2000, AU

(21) Appl. No.: 10/459,504

(22) Filed: Jun. 12, 2003

Related U.S. Application Data
(60) Provisional application No. 60/390,154, filed on Jun. 21, 2002.
(60) Provisional application No. 60/389,666, filed on Jun. 19, 2002.
(60) Provisional application No. 60/390,087, filed on Jun. 21, 2002.

(51) Int. Cl. H04N 5/225

(52) U.S. Cl. 348/207.1

(57) ABSTRACT

An internet-connected digital camera is disclosed, comprising a camera device with connectivity hardware, allowing connection to the Internet, and a web-enabled application program to control the camera. The camera is configured using the web application. Once connected to the Internet (by whatever means), the configuration information is sent from the web application to the camera. The configuration includes image specifications (e.g. color or black and white), trigger specifications (e.g., collect images based on the time or based on motion detection), and connection specifications (e.g., phone number to use to connect via modem). Once installed and configured, the camera collects, then connects and transmits images to the web application to be viewed at a later timer, or viewed in real time. Images may also be sent via e-mail to a specified account.

### FIELD OF THE INVENTION

This invention relates generally to digital cameras and specifically to digital cameras (still or moving image) connected to a computer network for the purpose of for example, configuring the camera or displaying images or both of these.

### BACKGROUND

The use of the Internet for transmitting images, both still pictures and motion video, is widespread. A major use of these cameras is as a camera fixed in position watching a scene and sending images either on a schedule, or when motion is detected within the viewing scene. These cameras are used for security, for example, set to view an entrance to a room or restricted space. They are also used for entertainment or enjoyment, for example, set to view a favorite locale or event. These cameras are connected by whatever means to a computer system running software which collects or sends still or motion video images through the Internet to other computer systems for processing or display.

This software is typically responsible the scheduling of the operation of the camera, and the disposition of the camera images. Specifically, a camera may be in full-time use, or it may be scheduled to be on or off at specific times during the day. Alternatively, the camera may be off until motion is detected, at which time the camera turns on, captures images while motion is still detected, then turns off, waiting future motion detection events. Finally, the camera may be in an on-demand mode, where some operator of the software initiates the camera collection and transmission of images. These operations are performed by a computer operator, issuing commands or otherwise interacting with the computer software.

Thus such cameras may require computer skills on the part of the user. The camera is not useful until the computer software is installed. In addition, the configuration of the camera, the downloading of images, the maintenance of the camera and other routine and exceptional processes of the camera may require the use of the camera-specific computer programs. That is, the user of a digital camera needs non-photographic computer skills which are not required of a user of a film or video tape camera for even the routine process of collecting and seeing photographic images.

What is needed is a digital camera which does not require computer skills on the part of the computer user to install, maintain, or use beyond the skill necessary to run an Internet browser program, a skill which is generally and widely available and simply acquired by even first-time computer users. It is therefore an object of the present invention to allow the user to take still or motion video images and see them on a computer system without computer skills beyond that of using an Internet browser program; no special camera-specific software skills are needed. It is another object of the present invention to allow the camera to be connected through other standard communication methods, for example, Local Area Networks (LAN's), Wide Area Networks (WAN's), wireless networks (for example, Bluetooth), or Public Service Telephone Networks (PSTN's), and others by simply connecting the camera to the network through network standard cables or connectors. It is yet another object of the present invention to allow the installation and configuration of the digital camera to be done through the use of an Internet browser. This method of use enables novel business models and types of uses to be supported.

### SUMMARY OF THE INVENTION

A digital camera is disclosed which allows the user to install, maintain, and use the camera without computer knowledge beyond that necessary to use an Internet browser program. The digital camera has, in addition to the image collection and storage hardware, has communications hardware and on-board logic allowing it to connect to the Internet. This connection may be through a number of communications protocols, for example, LAN, WAN, PSTN, and wireless. The digital camera interacts with two computer programs through the Internet, one which installs and maintains the camera itself, and one with collects and makes the camera images available to the camera user through an Internet browser. Appropriate security and identification processes are in place to prevent unauthorised access to the camera or camera images. In this specification, the term “user” will denote the camera operator, the person that purchases the web based services and thereby controls the camera which is sometimes remote from the user.

The camera process of collecting and transmitting images may be initiated by a user through a telephone. In this mode, when dialled, the camera initiates connection to a networked server through its on-board communications facilities.

The camera may also, after having been configured, initiate the collection and transmission of images through internal events, such as timer, or motion detection, or other. When such an event is detected by the camera, it initiates connection to the computer program if necessary, then collects and transmits images according to the pre-set parameters.

### BRIEF DESCRIPTION OF THE DRAWINGS

FIG. 1 illustrates the flow process for the Internet camera of the present invention.

FIG. 2 illustrates the logic diagram for the Internet camera connection.

### DETAILED DESCRIPTION

A computer system is connected to the Internet through a communications connection. Such a system typically consists of a computer processor, input devices (keyboard, mouse, etc.), a display monitor, output devices (printers, etc.), communications connections, and magnetic or optical storage devices. Such a computer system is connected to the Internet by the communications connection, communicates with other Internet-connect computers and devices through a variety of protocols, for example, File Transfer Protocol (FTP), Simple Mail Transfer Protocol, and Hyper Text Transfer Protocol (HTTP). Programs using these protocols are widespread and many have user interfaces which are simple and easy to learn even for people with no computer skill or experience, and include file transfer programs, Internet browsers, and electronic mail (e-mail) “clients” for sending, receiving, and displaying messages between Internet users.

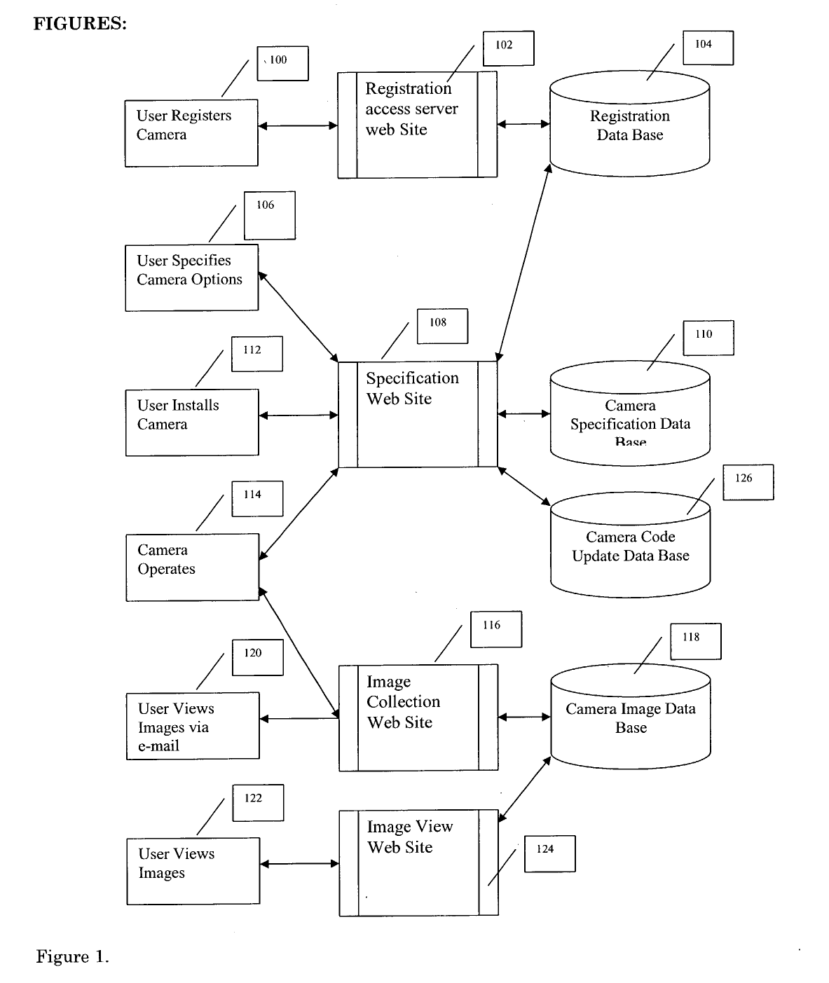

Referring now to FIG. 1. A customer, subscriber or “user” purchases or otherwise obtains the digital camera of the present invention. Packaged with the camera are instructions for registering the camera. The user registers the camera 100 by connecting to the Internet and directing their browser to the instructed registration access server web site 102. The registration access server web site 102 interacts with the user who provides typical information such the name and address of the purchaser, the camera serial number or other unique identifier, the date and place of purchase, possibly other details and demographic information of use to the camera manufacturer or distributor. The registration access server web site then allows the user to specify a unique user name and password which identifies the user for subsequent interaction with the web site. The information collected during the registration process is saved in a secure registration data base 104 for later reference.

When the registration process is complete, the user is sent, or requested to direct their browser, to the camera specification web site 108. There, the user specifies the camera options 106. To achieve this, they log in using the assigned user name and password to configure the camera first-time use specification. The user interacts with the specification web site to provide the type of connection (LAN, telephone, etc.) and location of the camera (which is not necessarily the same as the address of the registered user). The location of the camera is used to provide (later and to the camera itself) a local phone number for subsequent camera connection to the Internet. The user may specify additional options, for example:

1. Schedule start and end times to collect images. For example, Monday through Friday, 8.00 a.m.

2. Image size, quality (resolution), and type (how many colors, or black and white).

3. Stimulus or trigger event. For example, motion detection, timer, or external signal (incoming phone call, etc.).

4. Post-event period for image collection. For example, 10 minutes or 10 hours.

5. Image rate. For example, two images per second.

6. Pre- and post-event collection ratio. This allows images prior to the event to be included. For example, when motion is detected, include images before the motion detection event. The ratio gives allows the camera to calculate the number of pre-event images to buffer and transmit, based on the image rate and post-event period. As an example, if the stimulus is motion detection, and the post-event is 5 minutes (300 seconds) with an image rate of four images per second (1200 images) and a ratio of 10/90, then when motion is detected, 120 images (30 seconds) before the motion detection event, and 1080 images (4 minutes 30 seconds) after the event are transmitted.

7. Other specifications may also be collected at this time.

Additional services may be provided at additional cost to the user. For example, the purchase of the camera may include an amount of picture storage, which storage may be increased for an additional one-time or periodic amount. If the services selected result in additional cost, the user is prompted for payment information. When the user has entered and verified all configuration selections, the information is saved as data in camera specifications data base 110 for later retrieval and the user logs off the specification web site 108.

The user may return to specify camera options 106 at any time in the future to add or change desired options or other information. Interaction with the specification web site, these additions or changes are stored in the camera specification data base 110.

The next step is to install the camera 112. This may be done in any location where the camera can be connected to the Internet. This comprises connecting the camera to the network via the camera on-board communications facilities. If the camera is connected via telephone, a standard telephone line is plugged into the on-board modem of the camera and then into a standard telephone jack at the camera installation location. When installing via LAN or other communications connection, the camera is connected to the appropriate network using the appropriate cable and other hardware. Once installed, the camera is ready for operation. The camera is then powered up and it detects that the factory pre-set number is present. The camera's modem dials the pre-set number (for example a toll free number) and is connected to the registration access server 108. When connected, the registration access server identifies the camera by its unique identification and performs the following steps:

1. One or more Internet time servers are queried for the current correct time and the camera's clock is set.

2. The configuration details specified by the user in 106 are loaded to the camera, including the local POP access server details based on the camera's location. These details are retrieved from the camera specification data base 110 based on the camera's unique identification.

3. The camera's programming revision level is inspected and if necessary, software updates are downloaded from the camera code data base 126 to the camera and installed.

The camera is now configured with the correct time, the user specified configuration options, updated software if necessary, and the phone number of the local POP access server. The camera's modem now disconnects from the registration access server 108.

Subsequently, when the camera is powered up, it will connect to the local (e.g. POP) access server 116 if any of the following conditions are present:

1. The camera is powered up and has a local POP access server connection number. That is, the factory pre-set number has been replaced by a different number such as a local access number.

2. The camera is operational and has images to transmit. That is, the camera, based on its configuration, is triggered by motion detection, external trigger, or a time, to begin to collect images. The camera will connect to transmit the collected images to the local POP access server 116.

3. The camera has detected that it needs to go on-line to recheck its configuration. This could be as a result of an exceptional condition, for example, a required resource or option is no longer present in the camera. Or it could be a routine condition, for example, periodic checks for updated software.

The camera is now configured to operate, has up to date time, user specifications, and software levels. It now waits to “awaken” based on the user-specified trigger or collection events, for example, timer, motion detection, or external signal such as an incoming phone call. When awakened, the camera takes to following actions:

1. If not connected to the local POP access server, it connects, using the local access number if connection is via phone, or the specific method for connection based on the type of communication connection, camera location, and user selection.

2. When connected, routine checks are made, for example, to update time, software, or configuration parameters.

3. When connected and all routine checks are complete and all updates have been installed, the camera begins to collect and transmit images based on the user specifications. Referring again to FIG. 1. The camera operates 114 by establishing a connection to the local POP access server 116 as above. Images are transmitted from the camera 114 to the local POP access server 116, which based on the camera unique identifier, stores the images in the user's image account in the camera image data base 118.

When these actions are complete, the camera disconnects from the local POP access server 116 and waits for the next activation signal. This may be a timer event, an external event such as an incoming phone call, or a motion detect event. When activated, the camera takes the following actions:

1. It connects to the local POP access server using the local access phone number.

2. It performs the routine checks as above, it then, based on the configuration parameters begins to collect and transmit images. These images are stored in the camera image data base 118. These images may accumulate, that is, new images may be added to the user's account in the camera image data base 118, or they may replace previously stored images.

3. When the time for collection expires or count of images to collect is reached, the camera disconnects from the local POP access server 116 and waits for the next event.

4. If selected by the user, the local POP access server may package the collected images (or just an alert) for delivery to the user (or their designee) via electronic mail (e-mail). Using this option, the user has specified a recipient user identification address which is stored in the camera specification data base 110 and available to the local POP access server 116. A cover note is composed, the images are attached, as required and the e-mail is sent to the specified user address using SMTP or other e-mail protocol.

5. Once sent, the images may be retained or deleted based on user-specified parameters.

At some time later, the user may review the collected images. To do this, the user 122 logs onto the image viewing web site 124 using their selected or assigned user identification and password. The user then interacts with the image view web site 124 to review the collected images from the camera image data base 118. The user may review, print, delete, download, send via e-mail, or perform other functions on the images. When through, the user logs off the image view web site 124.

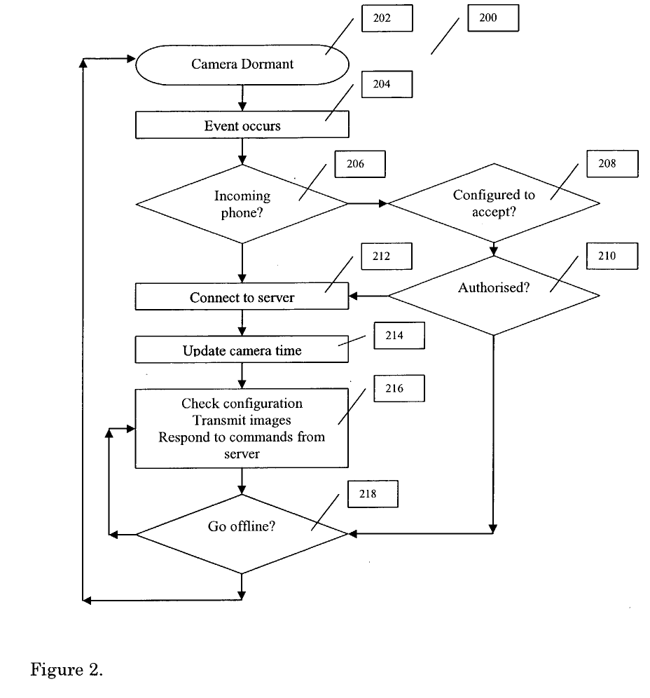

Referring now to FIG. 2. This illustrates the processing 200 of the internet camera of the present invention when activated by an event, such as an incoming phone call, motion detection, or a timer. Starting when the camera is installed, operational, and dormant 202, an even occurs 204. If this is an incoming phone call 206, a check is made 208 of the configuration of the camera to see if incoming calls are accepted. If not accepted, the event is ignored and the camera returns to the dormant state 202. If the camera is configured to accept incoming phone calls, a check is made 210 to see if the incoming call is authorised, that is, from an authorised phone number. If not authorised, the event is ignored and the camera returns to the dormant state 202. If the incoming call is authorised 210, the camera connects to the server 212. One way for the camera to connect is to detect a single or partial ring tone and use that as a trigger. The ring tone trigger causes the camera to wait a specified period before dialling out to the appropriate server. Once connected, the camera on-board clock is updated from the time server 214. The camera configuration is checked against the server configuration and updated if necessary 216. Also at 216, the camera collected images are uploaded to the image server. Also at 216, the camera receives and processes commands from the server. When complete with these items, the camera checks to see if it should go offline. For example, the time to go offline has been reached, the number of images to transmit has been transmitted, or the post-event time after motion detection has elapsed. If the camera is not to go offline, it returns to 216 to process the steps that need to be processed. Otherwise, the camera goes offline and return to the dormant state 202.

The present invention provides authentication of the user so that both the camera specification and images are protected from unauthorized access. To change the camera options, the user must use the process 106, connected to the specification web site by providing the user identification and, password. There is no other way to set or change the camera specification. The camera itself does not have access to the options and settings, so that while physical access to the camera may be by someone other than the authorized user, access to the options and settings within the camera are limited to the authorized user. Similarly, the images are not available to anyone except the user having the identification and password necessary to log onto the image view web site 124 using the image view process 122.

This camera provides function, security of images, and convenience beyond current art. It allows access to the options and settings of the camera and the camera images without specialised software installed on a personal computer connected to the camera. The camera options and settings, including date and time and software revision levels, are kept up to date without user request or intervention. The camera can recover from any unexpected loss of data through connection to the specification web site 108, where the lost data—including software, options, settings, etc.—are loaded to the camera whenever necessary when the camera connects. Finally, the user may specify new options and settings at any time, and these new settings are loaded to the camera automatically when the camera connects or at periodic intervals while the camera is connected so that the changes are activated as requested by the user.

What is claimed is:

1. A method for distributing digital images, comprising the steps of;
providing a digital camera having on-board logic and programmable communications hardware to a user or the user, the camera being adapted to connect to the internet without a PC and control itself from an on-board processor which obtains command instructions from a configuration server to which the camera can connect using its own communications hardware, the camera also being adapted to take images and transmit them to a collection server which provides access to the user; and
providing a registration server to which the user connects in a secure environment for the purpose of specifying user information which is stored on a registration database for later use,
providing an image viewing server from which the user or their designee may view images from an image database used by the collection server, the image viewing server obtaining information from the registration server for the purpose of authenticating the user.

2. The method of claim 1, further comprising the step of:
providing the user with an electronic form viewable on an internet browser by serving the form from the configuration server or the registration server, the configuration server collecting configuration information from the form and supplying commands to the camera, the commands being based on the configuration information.

3. The method of claim 1, wherein:
the camera can only be operated according to instructions or configuration information provided by the user through a secure server environment.

4. The method of claim 1, wherein:
the camera is activated by an incoming telephone call.

5. The method of claim 4, wherein:
the telephone call originates from an internet server or the user.

6. A digital camera, adapted to control itself from an on-board processor which obtains command instructions from a Internet server to which the camera can connect, without a PC, using its own communications device, the camera having a memory for storing images and being adapted to transmit images over the Internet in accordance with a schedule based on the command instructions.

7. The camera of claims 6, wherein:
the camera has a modem and a computer processor for managing the acquisition and transmission of images.

8. The camera of claim 6, wherein:
the camera is adapted to store a pre-set telephone number, which it uses to connect to a registration server to which it transmits a unique identification.

9. The camera of claim 8, wherein:
the camera is further adapted to receive, from the registration server, a second telephone number, which is stored by the camera, then used for subsequent dial-up connections.

10. The camera of claim 7, wherein:
the camera is activated by an incoming phone call, which caused the camera to dial a server.

11. The camera of claim 10, wherein:
the camera receives, if required, new configuration information from the server.

12. The camera of claim 11, wherein:
the camera is adapted to acquire and transmit images in accordance with configuration information, then return to a dormant state.

13. The camera of claim 7, wherein:
the processor is adapted to cause the storage or transmission of images based on an on-board motion detection trigger which detects an event.

14. The camera of claim 13, wherein:
the camera memory includes a buffer for storing pre-event images for transmission after the event.
